(19) United States
(12) Patent Application Publication
(10) Pub. No.: US 2016/0251159 A1
(43) Pub. Date: Sep. 1, 2016

(54) Hole-Free Rail Bracket

(71) Applicant: Swisslog Logistics, Inc., Newport News, VA (US)

(72) Inventors: Christopher Brumm, Ripon, CA (US); Pat Mitchell, Lathrop, CA (US); Mohan Ramankutty, Mountain House, CA (US)

(21) Appl. No.: 15/030,247

(22) PCT Filed: Oct. 20, 2014
(86) PCT No.: PCT/US2014/061372

§ 371 Date: Apr. 18, 2016

Related U.S. Application Data
(60) Provisional application No. 61/892,919, filed on Oct. 18, 2013.

(51) Int. Cl. B65G 1/04

(52) U.S. Cl. CPC B65G 1/0414

(57) ABSTRACT

A rail mounting bracket includes a base, first and second rail receiving recesses, and a plurality of rail support surfaces. The base includes an upper portion and a lower portion. The first rail receiving recess is formed in the upper portion and open in an vertical direction. The second rail receiving recess is formed in the lower portion and open in a horizontal direction. The plurality of rail support surfaces is positioned between the first and second rail receiving recesses and configured to support downward facing surfaces of a cart rail.

### TECHNICAL FIELD

The present disclosure relates to storage systems such as automated storage and retrieval systems (AS/RS), and more particularly to mounting brackets for coupling together rails and support beams of such storage systems.

### BACKGROUND

Automated warehouses and automated storage and retrieval systems (AS/RS) can reduce costs, pilferage, and damage because far fewer workers are needed for otherwise similar operations.

Retrotech Incorporated (Fishers, N.Y.) markets various automated warehouse systems and material handling robots. One such system, ACTIV™ is a mechanized material handling automation technology for continuous product flow. Loads are not assigned a location within a system, rather they are assigned a dynamic path into and subsequently through the system using a transport design that overcomes the limitations of conventional deep lane storage. The technology was originally marketed in Europe under the tradename ACTIV™ by Naaraharju Oy in Finland. Typical applications for ACTIV™ include existing warehouses which had their manufacturing sources nearby, and the packaging and palletizing lanes, loading docks, and other services were already in place.

The Retrotech system and other conventional approaches bog down and become inefficient as the design capacity is reached. Users cannot immediately access every pallet of product without having to “dig through” others to get to it. Systems like the Retrotech system have carts “slaved together” in groups that are constantly moving. Only one in the group is doing any useful work at any one time. One of the disadvantages of this system include that the carts' winch cables stretch and their drums wear out, and this affects the carts' ability to stop at the proper location. Another disadvantage is that this system requires a high degree of maintenance.

One challenge associated with AS/RS systems is the significant amount of time and effort required to assemble the rack system upon which the carts move and the pallets are stored. The rack system includes an assembly of support beams and cart rails. The cart rails are mounted to the support beams with mounting brackets. Typically, the mounting brackets are connected to the support beams with a plurality of bolts or other fasteners. The rails are then mounted to the brackets using a separate set of bolts. Abutting ends of the adjacent rails are secured together with splice plates, which are secured in place using a further set of bolts. One of the challenges associated with using bolts for assembling the rack system relates to forming the holes in the support beams, rails and splice plates through which the bolts extend. Even slight inaccuracies in the placement of the holes can create problems in the accurate positioning of the rails, particularly in large, multi-level rack systems.

Another challenge associated with using bolts for assembly of the rack system is the amount of time required to insert the bolts, attach the nuts to the bolts, and then tighten the nuts. Further, multiple workers are typically required to position a single rail because the rail must be held steadily in place while the bolts are inserted through the bolt holes. After assembly of the rack system is complete, further time is required to inspect each bolt to ensure tightening to specific torque specification. The time necessary for assembling and inspecting the rail system directly increases overall manufacturing costs since additional delays in assembly also delays the time for starting operation of the AS/RS system.

These and other challenges associated with AS/RS systems may be addressed by systems and methods disclosed herein.

### DISCLOSURE OF THE INVENTION

One aspect of the present disclosure relates to a rail mounting bracket that includes a base, first and second rail receiving recesses, and a plurality of rail support surfaces. The base includes an upper portion and a lower portion. The first rail receiving recess is formed in the upper portion and open in an vertical direction. The second rail receiving recess is formed in the lower portion and open in a horizontal direction. The plurality of rail support surfaces is positioned between the first and second rail receiving recesses and configured to support downward facing surfaces of a cart rail.

The plurality of rail support surfaces may be oriented horizontally. The base may have a thickness that is at least an order of magnitude less than a height and a width of the base. The first rail receiving recess may be positioned vertically above the second rail receiving recess. The first and second rail receiving recesses may include tapered openings. The plurality of rail support surfaces may include at least three horizontally oriented surfaces. At least some of the plurality of rail support surfaces may be formed as flanges extending laterally from the base. The rail mounting bracket may be formed from sheet metal and has a unitary, single piece construction.

Another aspect of the present disclosure relates to a rail mounting bracket that includes first and second rail connection recesses and at least two horizontally arranged rail support surfaces. The first rail connection recess is configured to receive a first free edge of a cart rail. The second rail connection recess is configured to receive a second free edge of the cart rail. The at least two horizontally arranged rail support surfaces are configured to support surfaces of the cart rail. The first and second rail connection recesses are arranged non-parallel with each other.

The first and second rail connection recesses may be arranged perpendicular to each other. The rail support surfaces may be arranged at spaced apart locations between the first and second rail connection recesses. The first rail connection recess may be positioned at a top end portion of the rail mounting bracket and may be open in a vertical direction. The second rail connection recess may be positioned at a bottom end portion of the rail mounting bracket and may be open in a horizontal direction.

A further aspect of the present disclosure relates to a method of assembling a rail system. The method includes providing at least one support beam, at least one rail mounting bracket, and at least one cart rail, the at least one rail mounting bracket including first and second rail connection recesses. The method further includes mounting the at least one rail mounting bracket to the at least one support beam, inserting a first free edge of the at least one cart rail in the first rail connection recess, and inserting a second free edge of the at least one cart rail in the second rail connection recess to provide an interference-fit connection between the at least one rail mounting bracket and the at least one cart rail.

The at least one rail mounting bracket may include a plurality of horizontally oriented rail support surfaces, the method may further include supporting downward facing surfaces of the at least one cart rail on the plurality of rail support surfaces. Inserting the second free edge may include applying a compression force to the at least one cart rail to move the first and second free edges toward each other. The method may include welding separate rail mounting brackets to opposing sides of the at least one support beam and concurrently inserting the first free edge into the first rail connection recess of each rail mounting bracket and concurrently inserting the second free edge into the second rail connection recess of each rail mounting bracket.

Another example method of assembling a rail rack system includes providing at least one support beam, at least one rail mounting bracket, and at least one cart rail, mounting the at least one rail mounting bracket to the at least one support beam without use of fasteners, and mounting the at least one rail mounting bracket to the at least one cart rail without use of fasteners.

Mounting the at least one rail mounting bracket to the at least one support beam may include welding the at least one rail mounting bracket to the at least one support beam. Mounting the at least one rail mounting bracket to the at least one cart rail may include providing an interference-fit connection between the at least one rail mounting bracket and the at least one cart rail. Mounting the at least one cart rail to the at least one rail mounting bracket may include inserting first and second free edges of the at least one cart rail into first and second recesses formed in the at least one rail mounting bracket. The first and second recesses may be arranged perpendicular to each other.

The foregoing and other features, utilities, and advantages of the invention will be apparent from the following detailed description of the invention with reference to the accompanying drawings.

### BRIEF DESCRIPTION OF THE DRAWINGS

FIG. 1 is a perspective view of a portion of a warehouse system in accordance with the present disclosure.

FIG. 2 is a perspective view of a portion of the warehouse system shown in FIG. 1.

FIG. 3 is a close-up view of a rail bracket used to connect a cart rail to a support beam of the warehouse system shown in FIG. 2.

FIG. 4 is another perspective view of the rail bracket, cart rail and support beam shown in FIG. 3.

FIG. 5 is another perspective view of the rail bracket, cart rail and support beam shown in FIG. 3.

FIG. 6 is another perspective view of the rail bracket, cart rail and support beam shown in FIG. 3.

FIG. 7 is a perspective view of the rail bracket shown in FIG. 3.

FIG. 8 is a side view of the rail bracket shown in FIG. 3.

FIG. 9 is a side view of the rail bracket shown in FIG. 7 with a cart rail aligned for mounting to the rail bracket.

FIG. 10 shows the rail bracket of FIG. 9 with a first edge of the cart rail inserted into an upper rail receiving recess of the rail bracket.

FIG. 11 shows the rail bracket of FIG. 10 with a second edge of the cart rail aligned for insertion into a lower rail receiving recess of the rail bracket.

FIG. 12 shows the rail bracket of FIG. 11 with the first and second edges of the cart rail inserted into upper and lower rail receiving recesses of the rail bracket, respectively.

FIG. 13 is a perspective view of another example rail bracket in accordance with the present disclosure.

FIG. 14 is a perspective view of another example rail bracket in accordance with the present disclosure.

FIG. 15 is a perspective view of another example rail bracket in accordance with the present disclosure.

FIG. 16 is a perspective view of another example rail bracket in accordance with the present disclosure.

### BEST MODE(S) FOR CARRYING OUT THE INVENTION

The present disclosure is directed to warehouse systems, in particular rail systems having a plurality of rails that support automated rail carts for transporting goods within the warehouse. One aspect of the present disclosure is directed to mounting brackets used to mount the cart rails to support beams of the rail system. The brackets may be mounted to the support beams without the use of fasteners. Instead, other connection means may be used including welding. The cart rails may be mounted to the brackets also without the use of fasteners. For example, the cart rails may be mounted to the brackets with an interference-fit connection, a snap-fit connection, or other connection that does not require the use of a fastener.

In one example, the cart rail may include at least first and second free edges. The free edges are inserted into recesses or slots formed within the bracket. One assembly method may include inserting a first free edge of the cart rail into the first recess or slot of the bracket. The cart rail or a portion thereof may be flexed or compressed in order to insert the second free edge of the cart rail into a second recess or slot formed in the bracket. Releasing the force used to compress or flex the cart rail after aligning the second edge with the second recess allows automatic insertion of the second edge into the second recess. The second edge maintains the inserted position during use of the cart rail until the compression force is again applied.

The recesses or slots formed in the bracket may be arranged in different directions relative to each other. For example, the first recess may be positioned along an upward facing surface of the bracket and face in a vertical direction. The second recess may be formed in a lower portion of the bracket and face in a horizontal direction. Various arrangements are possible for the recesses including, for example, the position in which the recesses are placed on the bracket as well as the direction in which the recesses are accessible for receiving a free edge of the cart rail.

The brackets may also include a plurality of rail support surfaces that support other portions of the cart rail. For example, a bracket may include at least first and second horizontally arranged rail support surfaces that support downward facing, horizontally oriented surfaces of the cart rail when the cart rail is mounted to the bracket. The recesses of the bracket may provide a positive connection between the cart rail and the bracket. The rail support surfaces of the bracket may provide vertical support that assists in transferring the load applied to the cart rail through the bracket and to the support beam.

The bracket may have a unitary, single-piece construction. The bracket may have a thickness that is substantially less than a width and height of the bracket. In at least some examples, the thickness is at least an order of magnitude less than a width and height of the bracket. The bracket may be formed, in at least some arrangements, from a sheet of metal. The sheet may be stamped, cut, bent, cast or otherwise formed to create a single-piece bracket having the various features needed for mounting the cart rail to the bracket and also support the cart rail during use.

A plurality of brackets may be used for mounting a single cart rail to a plurality of support beams. The brackets may be distributed along the length of the cart rail. Multiple brackets may be used to connect the cart rail or a plurality of cart rails to a single support beam. The brackets may be mounted to side surfaces (e.g., opposing side surfaces) of a given support beam. The brackets may suspend the cart rails above top surfaces of the support beams to which the cart rails are mounted.

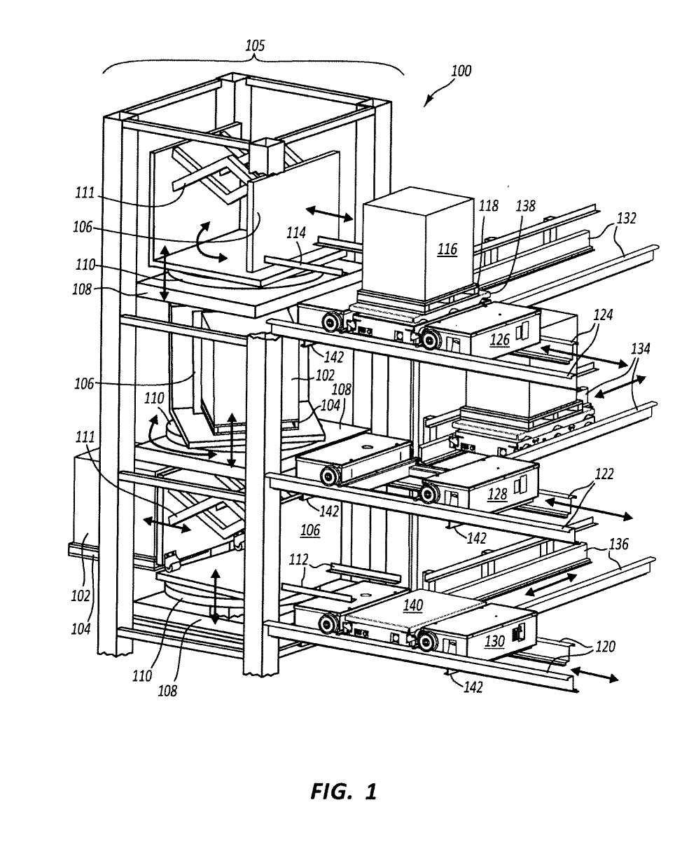

FIG. 1 illustrates a portion of a warehouse system 100 having the support beams, cart rails, and mounting brackets discussed above. The warehouse system 100 is preferably installed in a high profile warehouse building with at least one freight elevator. A product 102 on a standard pallet 104 is lifted and retracted into a loading elevator shaft 105 by a rotating forklift-like attachment (FLA) 106. A uniform pallet size is desired for a specific system. For example, a “standard” pallet in a grocery application would be a Grocery Manufacturers Association (GMA) pallet 40″×48″ with four way entry. An elevator car 108 supports a turntable 110 and the rotating FLA 106 which is mounted inside. The rotating FLA 106 can extend its forks to reach out and bring in or drop off product loaded on a standard pallet. For example, a scissors mechanism 111 allows an adequate reach to bring pallets in and out of the elevator car 108. Other types of mechanisms are also possible.

FIG. 1 shows three each of such rotating FLAs 106, elevator cars 108, and turntables 110, but in actual use only one such set would be present. These three sets are shown in FIG. 1 to illustrate the different phases of use that occur over time. The bottom set demonstrates incoming material being received. The middle set demonstrates the material being spun around and reoriented to face the warehouse system interior. The top set demonstrates the unloading of the elevator car and staging for transfer to the aisle cart.

Once the pallet 104 and product 102 are inside the loading elevator shaft 105, the rotating forklift 106 is spun around on the turntable 110 to face the interior levels of the warehouse system. When the pallet 104 and product 102 are transported and arrive at a particular level, the rotating FLA 106 extends out and deposits the product and pallet on a temporary support. An empty temporary pallet support 112 is shown on the bottom level as two opposing L-angle steel sections. A loaded temporary pallet support 114 is shown at the top level, also as two opposing L-angle steel sections (just below a product 116 and its pallet 118). Such pallet supports 112, 114 allow the elevator to drop off its incoming load, and then go on to another task. The corresponding outgoing pallet supports allow the aisle carts to drop off their outgoing loads, and then return to a designated location for another task. It should be understood that the previous two functions can be accomplished with one universal elevator.

Three sets of aisle rails 120, 122, 124 are shown for the three levels visible in FIG. 1. These railways run between the loading elevator shaft 105 to a corresponding unloading elevator shaft on the same level. Where only a single or universal elevator is used, then these railways run from the elevator to the far end of the system. Each level has one aisle cart 126, 128, 130 that shuttles along the aisle rails 120, 122, 124 between the temporary pallet supports 112, 114 for the loading elevator and an unloading elevator (not shown in FIG. 1). Perpendicular to the aisle rails 120, 122, 124 are several parallel row rails (e.g., an upper-level row rail 132, a middle-level row rail 134, and a lower-level row rail 136). Each level will typically have more than one row and associated sets of row rails. The aisle carts 126, 128, 130 carry battery powered piggyback or row carts that run back and forth along a row. A battery powered row cart 138 is shown docked atop its aisle cart 126. An empty row cart 140 is shown docked atop its aisle cart 130.

In operation, each aisle cart 126, 128, 130 is positioned in front of a designated row along the aisle rails 120, 122, 124, and the row cart (e.g., 138) delivers, deposits, and retrieves product on pallets along the rows. Storage supports are provided along both sides of each row for storing the product and pallet at a designated position.

The movement of the aisle carts, row carts, elevators, turntables, extending forklifts, etc., is preferably computer controlled. This type of control allows applications software to be in charge of all the material handling. The application software works in conjunction with inventory control software, such as AIM software available from TRW.

Position sensors are placed at strategic points to help inform the computer system as to the actual positions of the various moving components of the warehouse system. A scannable identification tag attached to each pallet that would uniquely identify the product being handled and any access or movement restrictions would be beneficial. Such identity tags are preferably used to track inventory, schedule storage locations, assist property security, schedule shipping, etc. The implementation of such a supervisory control and data acquisition (SCADA) system is straightforward and essentially quite conventional. The system provides loading and unloading elevators, aisle carts, and row carts which are all interrelated and used to transport product through the system.

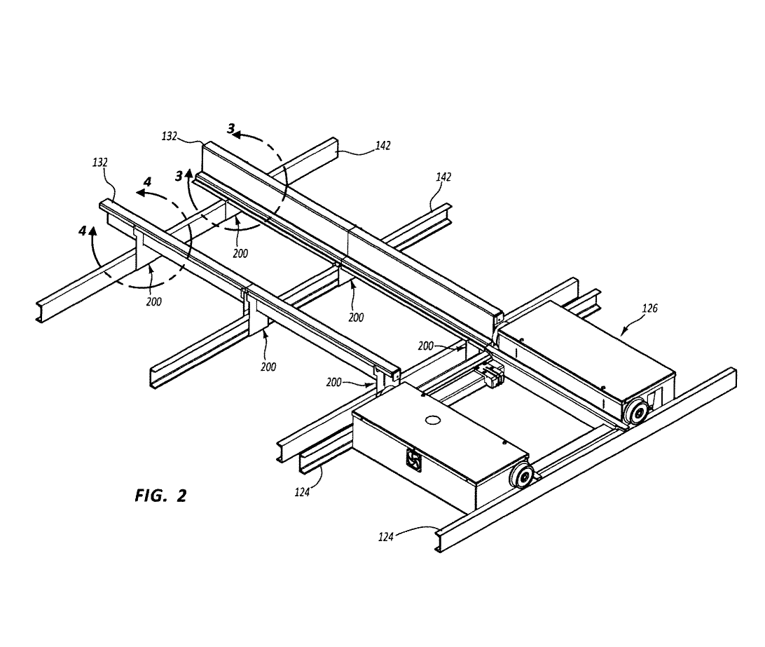

The warehouse system 100 shown in FIG. 1 includes a plurality of rail brackets (e.g., see rail brackets 200 in FIG. 2) that connect the aisle rails 120, 122, 124 and the row rails 132, 134, 136 (generally referred to as “cart rails”) to the support beams 142. The rail brackets may be used to connect at least some of the aisle rails 120, 122, 124 to at least some of the support beams 142. The rail brackets may also be used to connect at least some of the row rails 132, 134, 136 to at least some of the support beams 142. As shown and described below with reference to at least FIGS. 2-6, the rail brackets may be connected to the support beams in a preliminary step prior to assembly of the warehouse system 100. For example, the rail brackets may be mounted to the support beams at a factory or manufacturing facility prior to delivery to a remote construction site where the warehouse system is constructed.

The rail brackets may be mounted to the support beams 142 in any of a variety of ways including, for example, welding or other connection methods that are free of fasteners (e.g., bolts or screws). The rail brackets may include features that provide mounting of the cart rails to the support beams without the use of fasteners. For example, the rails may be mounted to the rail bracket with a snap-fit or interference-fit connection. This improved design for assembly of the cart rails to the support beams may have a number of advantages as compared to systems that rely on fasteners. Some example advantages include reduced complexity by reducing the number of parts required for the warehouse system 100, reduced costs related to reducing the amount of material and the labor required for assembly, and reduced time for assembling warehouse system 100.

FIG. 2 shows a portion of the warehouse system 100 including a plurality of aisle rails 124, a plurality of upper level row rails 132, and a plurality of support beams 142. The aisle rails 124 support at least one aisle cart 126. The row rails 132 are connected to the support beams 142 with a plurality of rail brackets 200. The row rails 132 are configured to support at least one row cart 138 (see FIG. 1). A separate bracket is used to connect each of the row rails 132 to each of the support beams 142. In some examples, a plurality of rail brackets may be used to connect one row rail 132 to each support beam 142. The aisle rails 124 may also be mounted to support beams, which are not shown in FIG. 2, using the rail brackets 200 or other types of rail brackets that do not require use of fasteners. The aisle rails 124 may have the same or similar design as the row rails 132 (e.g., see FIG. 1). Alternatively, the aisle rails 1214 may have a separate and distinct design as compared to the row rails 132 (see FIG. 2).

The row rails 132 may be connected to rail brackets with a snap-fit or interference-fit connection. The row rails 132 may be connected to rail brackets 200 without the use of fasteners (e.g., bolts, rivets, screws, etc.). The rail brackets 200 may be mounted to the support beams 142 using, for example, a temporary connection (e.g., removable fasteners) or a permanent connection that does not require use of fasteners (e.g., welding or adhesives). In at least some embodiments, a combination of connection features, including, for example, snap-fit/interference-fit connections, fasteners, and welding, may be used to assemble various portions of the warehouse system 100.

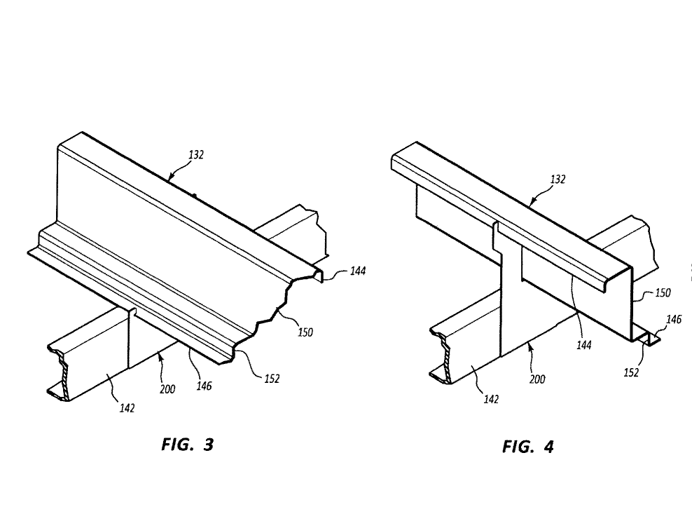

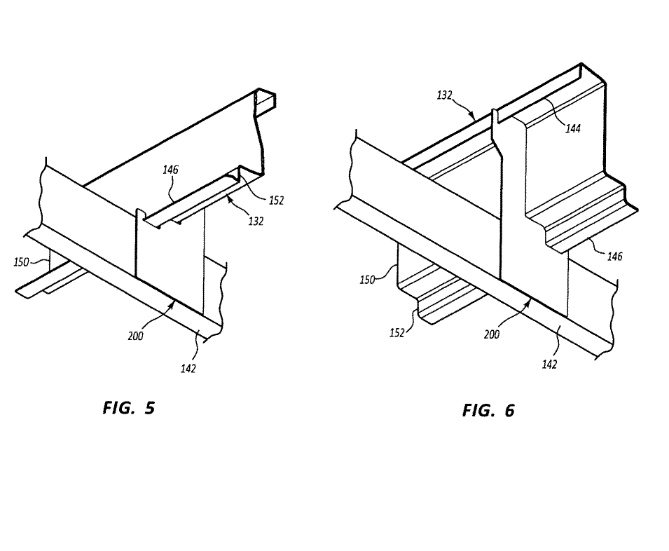

FIGS. 3-6 show close up views of portions of the warehouse system 100 show in FIG. 2. FIG. 3 shows a second rail edge 146 of row rail 136 inserted into a recess or slot of the rail bracket 200. FIG. 4 shows a first rail edge 144 of the row rail 136 inserted into a separate recess or slot in the rail bracket 200. FIGS. 5 and 6 show bottom perspective views of the first and second rail edges 144, 146 inserted into the recesses or slots of rail bracket 200 to provide a positive connection between the row rail 136 and the rail bracket 200. FIGS. 3-6 show the row rail 136 including vertical portions 150, 152 interposed between the first and second rail edges 144, 146. The snap-fit connection between the row rail 136 and rail bracket 200 may provide a releasable connection between row rail 136 and support beams 142, and may eliminate the requirement for splice plates between adjacent rails.

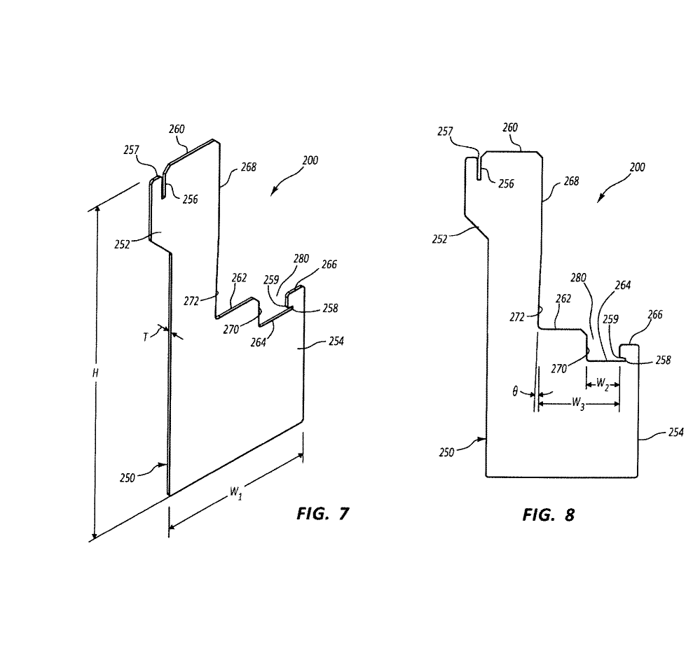

Referring to FIGS. 7 and 8, the rail bracket 200 is shown including a base 250 having upper and lower portions 252, 254. An upper rail receiving recess 256 is formed in the upper portion 252. A lower rail receiving recess 258 is formed in the lower portion 254. The upper and lower rail receiving recesses 256, 258 may include tapered openings 257, 259, respectively. Rail bracket 200 also includes first, second, third and fourth horizontal rail support surfaces 260, 262, 264, 266, and first and second vertical rail support surfaces 268, 270. The first vertical rail support surface 268 may include a cutback or recessed portion 272 along at least a portion of its length. Other embodiments may provide the desired functionality without the use of cutback portion 272. The cutback portion 272 may be tapered from the remaining portions of first vertical rail support surface 268 at an angle θ (see FIG. 8) in the range of about 1° to about 20°, more particularly about 3° to about 10°, and in at least one example may be about 5°. The cutback portion 272 may increase in depth moving toward the second horizontal support surface 262. The rail bracket 200 may have a width W₁, a height H, and a thickness T (see FIG. 7).

The upper rail receiving recess 256 is oriented vertically with an access opening facing upward when the rail bracket 200 is positioned in a vertical orientation (e.g., the orientation shown in FIG. 2). The lower rail receiving recess 258 is oriented horizontally with an access opening facing in a horizontal direction when the rail bracket 200 is oriented vertically. The perpendicular arrangement of the upper rail receiving recess 256 relative to the lower rail receiving recess 258 may provide for improved locking and positive attachment of the row rail 132 to the rail bracket 200. The row rail 132 may be compressed, biased or elastically deformed in order to position both free edges of the rail into the upper and lower rail receiving recesses 256, 258, respectively. Releasing the force needed to compress, bias or elastically deform row rails 132 may result in portions of row rail 132 applying a return bias force that helps maintain the rail edges 144, 146 positioned within the upper and lower rail receiving recesses 256, 258.

The upper and lower rail receiving recesses 256, 258 may be positioned at other locations on the base 250. Further, the upper and lower rail receiving recesses 256, 258 may be oriented facing in other directions and in any positioned at any desired orientation relative to each other, including being arranged parallel to each other and facing in opposite directions.

The upper and lower rail receiving recesses 256, 258 may be sized and configure to receive other portions of a rail besides a free edge thereof. For example, a bend, fold or other feature formed in the rail may be sized and arranged to be inserted within one of the upper and lower rail receiving recesses 256, 258. In some examples, other features of the rail bracket besides a recess or slot may be used to provide the positive connection between the rail and the rail bracket while still providing the desired positive connection between the rail and the rail bracket without the use of fasteners. For example, a lip, a protrusion, or a corner of the rail bracket may provide a connection feature.

The tapered openings 257, 259 may provide improved ease of insertion of a portion of the rail into the upper and lower rail receiving recesses 256, 258. In some arrangements, the upper and lower rail receiving recesses 256, 258 may be tapered along their entire length rather than at only an open end thereof. An opening width of the upper and lower rail receiving recesses 256, 258 may substantially match a material thickness of the portion of a rail that is inserted therein.

The rail surface supports 260, 262, 264, 266 may be arranged facing generally upward and configured to support a downward facing surface of a rail. The load applied to the rail by a cart carried thereon may be transferred through the rail support surfaces 260, 262, 264, 266, through the base 250, and into the support beam to which the rail bracket is mounted. While the rail support surfaces 260, 262, 264, 266 are arranged generally horizontally, other configurations are possible in which the rail support surfaces have different orientation such as an angled orientation relative to the horizontal and vertical planes.

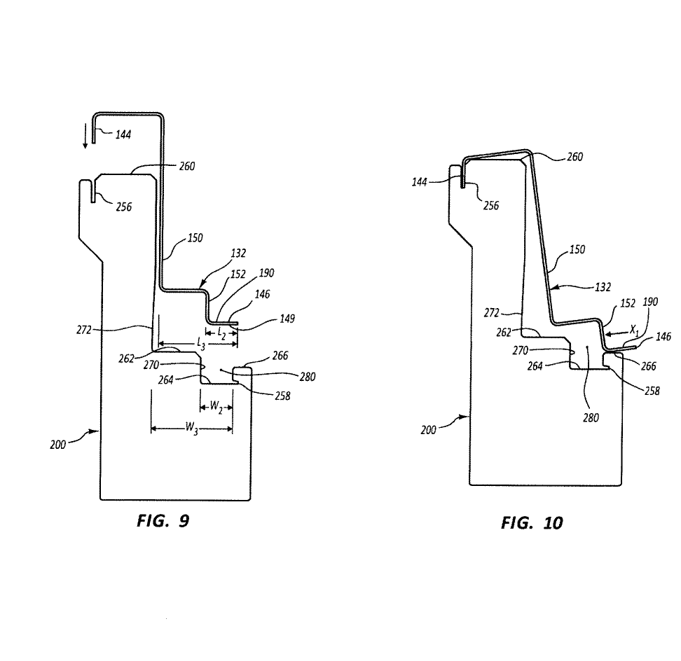

The area of third support surface 264 may be referred to as a recess or cut out 280 which has a width W₂ (see FIG. 8). The width W₂ is typically greater than a length L₁ of that portion of the row rail 136 having the second rail edge 146, as shown and described below with reference to FIG. 9. This width W₂ permits insertions of row rail through gap or opening 280 for insertion of second rail edge 146 into the lower rail receiving recess 258.

The first and second vertical rail support surfaces 268, 270 may extend between the first and second rail support surfaces 260, 262 and between the second and third rail support surfaces 262, 264, respectively. The first and second vertical rail support surfaces 268, 270 may support vertically oriented and laterally facing surfaces of the rail. The first and second vertical rail support services 268, 270 may provide lateral support for the rail.

The width W₁ of rail bracket 200 is typically less than the height H. The thickness T is typically at least in order of magnitude less than both of the width W₁ and height H. The rail bracket 200 may be formed from sheet metal, and the features of the rail bracket 200 are cut, stamped or otherwise formed in rail bracket 200 using, for example, precision machining.

The rail bracket 200 is designed to have maximum strength in a vertical direction to be able to support a load applied vertically to the cart rail attached thereto. Other features may be added to the rail bracket to increase strength in the vertical and other directions such as in front-to-back and side-to-side directions.

Referring now to FIGS. 9-12, an example method of mounting a rail 132 to rail bracket 200 is shown in sequential steps. FIG. 9 shows the rail 132 arranged vertically above the rail bracket 200 with first and second rail edges 144, 146 generally aligned vertically above the upper and lower rail receiving recesses 256, 258. The rail 132 is in a rest state or rest position in FIG. 9. The rail bracket 200 is typically mounted in advance to a support beam 142 prior to mounting the rail 132 to rail bracket 200. An end portion 190 of rail 132, which includes the second rail edge 146, has a length L₁ that is less than a width W₂ of a gap 280 in base 250 that provides entrance into the third rail support surface 264 and the lower rail receiving recess 258.

FIG. 10 shows the first rail edge 144 inserted into the upper rail receiving recess 256. The end of rail 132 that defines the second rail edge 146 typically contacts the fourth rail support surface 266, which prevents the second rail edge 146 from being inserted into the lower rail receiving recess 258. A compression force is applied to the rail 132 in a direction X₁, which may create some bending or flexing within the rail bracket 200. For example, vertical portion 150 may bend or flex into cutback 272 upon application of a force in direction X₁. Vertical portion 152 may also bend or flex to permit portion 190 to be aligned with and inserted into gap 280.

The application of the force in direction X₁ may move the first and second rail edges 144, 146 towards each other and may create a biasing force within the rail bracket 200. The force in direction X₁ may be applied to rail 132 (e.g., directly or adjacent to rail edge 146) using, for example, a tool such as a hammer, or a user's foot.

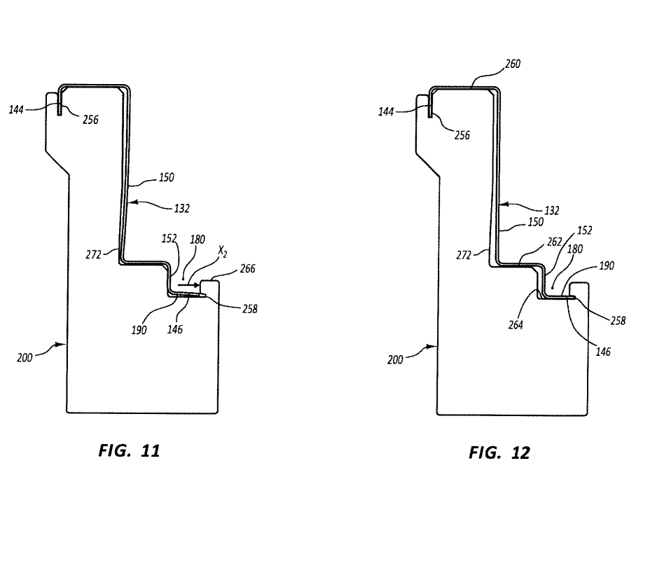

FIG. 11 shows the portion 190 of rail 132 positioned within the gap 280 with the second rail edge 146 horizontally aligned with, but not yet inserted into, the lower rail receiving recess 258. Once the force in direction X₁ is released after the portion 190 is oriented in the position show in FIG. 11, the rail 132 automatically moves into its original or rest state, which results in the second rail edge 146 moving horizontally into the lower rail receiving recess 258 in the direction X₂.

FIG. 12 shows the second rail edge 146 positioned within a lower rail receiving recess 258. The first and second rail edges 144, 146 may be maintained within the upper and lower rail receiving recesses 256, 258 with an interference-fit or under a biasing force that creates a snap-fit connection. The first and second rail edges 144, 146 typically remain positioned within the upper and lower rail receiving recesses 256, 258 until a force is again applied in the direction X₁. Since most of the forces applied to rail 132 during operation of the warehouse system 100 are in a vertically downward direction as applied by wheels of the rail carts, and are not forces applied in a lateral direction, the rail 132 remains connected to the rail bracket 200 unless intentionally disconnected therefrom by an operator who applies a force in the direction X₂ to the rail 132 to move the second rail edge 146 out of the lower rail receiving recess 258.

After the row rails 132 and rail brackets 200 have been installed, we the portions 190 of rail brackets 200 may be further secured to support beam 142 with a fastener, such as a self-drilling/self-taping screws. The fastener may extend through the portion 190, or other portion of row rail 132, and into support number 142. The fastener may help prevent the row rail 132 from sliding along its length relative to the rail bracket 200 and support beam 142. If the row rail 132 were to slide along its length after being attached to the rail brackets 200, all of the rail brackets 200 would bend in the direction of sliding. During operation of the rail system, there typically are not many forces applied to row rail 132 in an axial direction which would cause the row rail 132 to move along its length. However, the rail bracket 200 has its weakest orientation in the axial direction of the row rail 132 and may have limitations in its ability to hold the row rail 132 against axial movement. Using a fastener as described above (e.g., screwing the portion 190 to the support beam 142), limits the undesirable axial movement of row rail 132 and allows the rail bracket 200 to function with its strongest features able to contribute to the integrity of the structure while limiting its weak orientation.

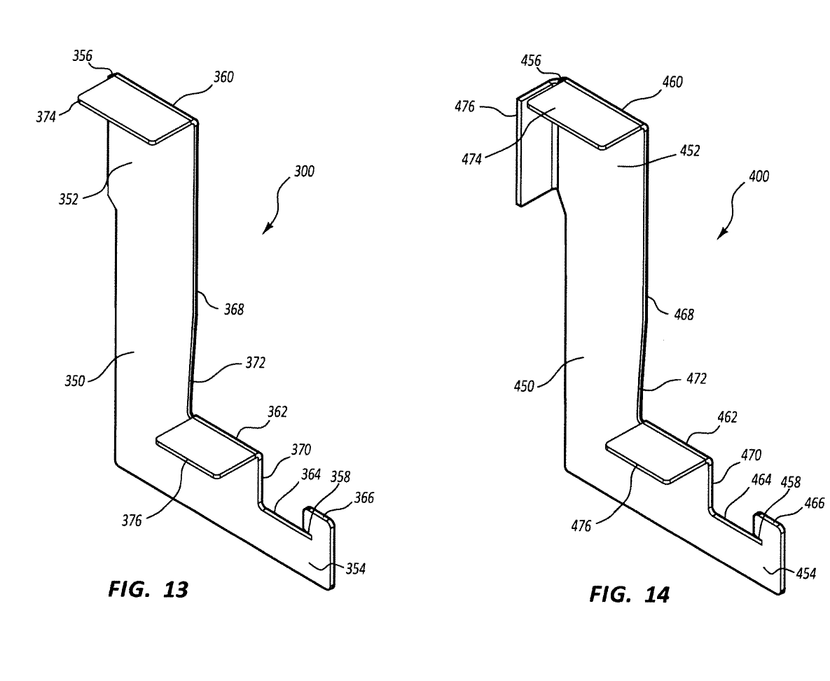

FIGS. 13-16 show alternative embodiments for a rail bracket. FIG. 13 shows a rail bracket 300 having a base 350, an upper rail portion 352, a lower portion 354, upper and lower rail receiving recesses 356, 358, horizontal rail support surfaces 360, 362, 364, 366, vertical rail support surfaces 368, 370, and cutback portion 372. Rail bracket 300 also includes a plurality of horizontal flanges 374, 376 that provide additional support for downward facing surfaces of the rail. The horizontal flanges 374, 376 may provide increased surface area for the first and second horizontal support surfaces 360, 362.

FIG. 14 shows another example rail bracket 400. The rail bracket 400 includes a base 450 having upper and lower portions 452, 454, upper and lower rail receiving recesses 456, 458, horizontal rail support surfaces 460, 462, 464, 466, first and second vertical rail support surfaces 468, 470, and cutback portion 472. Rail bracket 400 also includes a plurality of horizontal flanges 474, 476 that provide increased surface area for the first and second horizontal rail support surfaces 460, 462. Rail bracket 400 also includes a vertical flange 478. The vertical flange 478 may support a vertical surface of the rail or a surface of the support beam that faces in a lateral direction. Vertical flange 478 may provide increased support or stability of the rail. The vertical flange 478 may be positioned at the upper portion 452 adjacent to the horizontal rail support surface 460 and the upper rail receiving recess 456.

FIG. 15 shows a rail bracket 500 having a base 550, upper and lower portions 552, 554, upper and lower rail receiving recesses 556, 558, horizontal rail support surfaces 560, 562, 564, 566, vertical rail support surfaces 568, 570, and cutback portion 572. Rail bracket 500 also includes a plurality of horizontal flanges 574, 576 and at least one vertical flange 578. Vertical flange 578 may provide increased support and stability for the rail mounted to the rail bracket 500. Vertical flange 578 may provide an interface between adjacent support beams or other features of the warehouse system 100. Vertical flange 578 may be positioned at the lower portion 554.

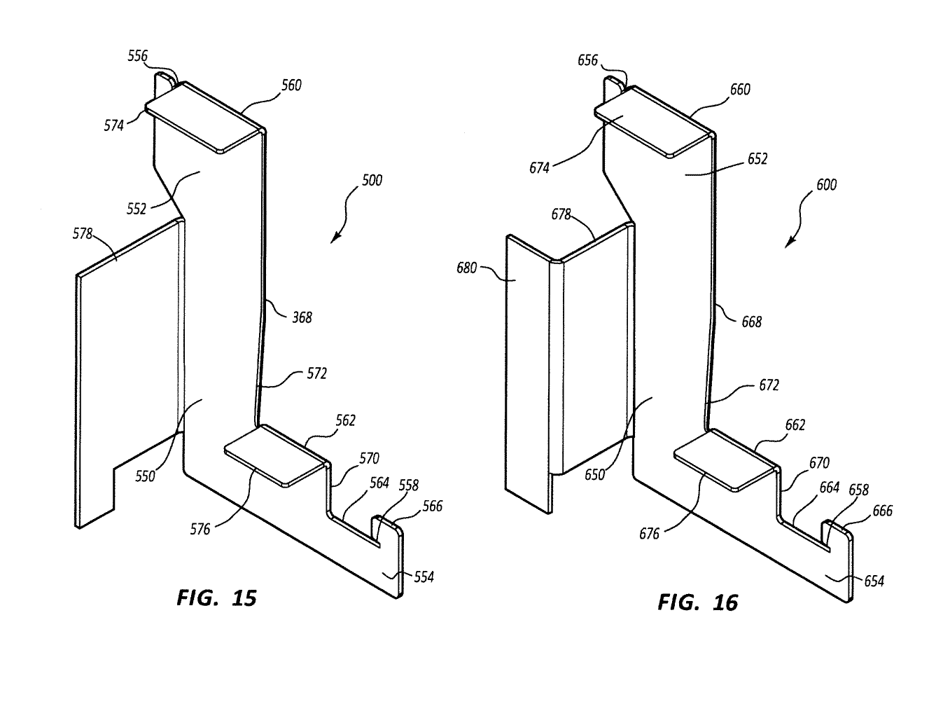

FIG. 16 shows a rail bracket 600 having a base 650 with upper and lower portions 652, 654, upper and lower rail receiving recesses 656, 658, horizontal rail support surfaces 660, 662, 664, vertical rail support surfaces 668, 670, and cutback portion 672. Rail bracket 600 may include a plurality of horizontal flanges 674, 676 and a plurality of vertical flanges 678, 680. The horizontal and vertical flanges may provide mounting surfaces for connecting rail bracket 600 to support beams or various rails of the warehouse system, and may also support portions of the rails.

Other embodiments may include additional flanges or other features extending from various edges or surfaces of the rail bracket to provide desired mounting and support functions. The flanges may be integrally formed with the remaining portions of the rail bracket. For example, a rail bracket may be formed from a unitary piece of sheet metal which is bent and shaped to include the flanges and other features of the rail bracket (e.g., the upper and lower rail receiving recesses). In other arrangements, the flanges may be separately formed and connected to the rail bracket using an attachment method such as welding.

An example method of assembling a rail system for a warehouse may include providing a plurality of support beams, a plurality of rail mounting brackets, and a plurality of cart rails. The rail mounting brackets may include first and second rail connection recesses or slots. The rail mounting brackets are connected to the support beams using, for example, welding or other permanent connection method. A first free edge of the cart rail is inserted into the first rail connection recess. A second free edge of the cart rail is inserted into the second rail connection recess after the first free edge is inserted. The connection between the cart rail and the rail mounting bracket may be a snap-fit or interference-fit connection that provides a positive connection between the cart rail and the rail mounting bracket. The connection between the cart rail and the rail mounting bracket may be created without the use of fasteners. Further, the cart rail may be disconnectible from the rail mounting bracket so as to provide disassembly of the rail system. The first and second rail connection recesses may be oriented at an angle relative to each other such as, for example, a perpendicular orientation relative to each other.

Mounting the rail mounting brackets to the support beams may be done using other connection methods besides welding. The connection of the rail mounting brackets to the support beams may be performed at a location remote from the location in which the cart rail is mounted to the rail mounting bracket. For example, the rail mounting brackets may be mounted to the support beams at a manufacturing or factory facility using precision connection machinery such as automated welding equipment. Connecting the rail mounting brackets to the support beams prior to assembling the cart rail to the rail mounting bracket at an installation site (e.g., at a warehouse) may provide more precise positioning of the rail mounting bracket on the support beam and reduce time for assembling the rail rack system at the installation site.

The preceding description has been presented only to illustrate and describe exemplary embodiments of the invention. It is not intended to be exhaustive or to limit the invention to any precise form disclosed. Many modifications and variations are possible in light of the above teaching. It is intended that the scope of the invention be defined by the following claims.

1. A rail mounting bracket, comprising:
a base having an upper portion and a lower portion;
a first rail receiving recess formed in the upper portion and open in an vertical direction;
a second rail receiving recess formed in the lower portion and open in a horizontal direction;
a plurality of rail support surfaces positioned between the first and second rail receiving recesses and configured to support downward facing surfaces of a cart rail.

2. The rail mounting bracket of claim 1, wherein the plurality of rail support surfaces are oriented horizontally.

3. The rail mounting bracket of claim 1, wherein the base has a thickness that is at least an order of magnitude less than a height and a width of the base.

4. The rail mounting bracket of claim 1, wherein the first rail receiving recess is positioned vertically above the second rail receiving recess.

5. (canceled)

6. The rail mounting bracket of claim 1, wherein the plurality of rail support surfaces include at least three horizontally oriented surfaces.

7. The rail mounting bracket of claim 1, wherein at least some of the plurality of rail support surfaces are formed as flanges extending laterally from the base.

8. (canceled)

9. A rail mounting bracket, comprising:
a first rail connection recess configured to receive a first free edge of a cart rail;
a second rail connection recess configured to receive a second free edge of the cart rail;
at least two horizontally arranged rail support surfaces configured to support surfaces of the cart rail;
wherein the first and second rail connection recesses are arranged non-parallel with each other.

10. The rail mounting bracket of claim 9, wherein the first and second rail connection recesses are arranged perpendicular to each other.

11. The rail mounting bracket of claim 9, wherein the rail support surfaces are arranged at spaced apart locations between the first and second rail connection recesses.

12. The rail mounting bracket of claim 9, wherein a least one of:
the first rail connection recess is positioned at a top end portion of the rail mounting bracket and is open in a vertical direction; or
the second rail connection recess is positioned at a bottom end portion of the rail mounting bracket and is opening a horizontal direction.

13. (canceled)

14. A method of assembling a rail system, comprising:
providing at least one support beam, at least one rail mounting bracket, and at least one cart rail, the at least one rail mounting bracket including first and second rail connection recesses;
mounting the at least one rail mounting bracket to the at least one support beam;
inserting a first free edge of the at least one cart rail in the first rail connection recess;
inserting a second free edge of the at least one cart rail in the second rail connection recess to provide an interference-fit connection between the at least one rail mounting bracket and the at least one cart rail.

15. The method of claim 14, wherein the at least one rail mounting bracket includes a plurality of horizontally oriented rail support surfaces, the method further comprising supporting downward facing surfaces of the at least one cart rail on the plurality of rail support surfaces.

16. The method of claim 14, wherein inserting the second free edge includes applying a compression force to the at least one cart rail to move the first and second free edges toward each other.

17. The method of claim 14, further comprising welding separate rail mounting brackets to opposing sides of the at least one support beam and concurrently inserting the first free edge into the first rail connection recess of each rail mounting bracket and concurrently inserting the second free edge into the second rail connection recess of each rail mounting bracket.

18. A method of assembling a rail rack system, comprising:
providing at least one support beam, at least one rail mounting bracket, and at least one cart rail;
mounting the at least one rail mounting bracket to the at least one support beam without use of fasteners;
mounting the at least one rail mounting bracket to the at least one cart rail without use of fasteners.

19. The method of claim 18, wherein mounting the at least one rail mounting bracket to the at least one support beam includes welding at least one rail mounting bracket to the at least one support beam.

20. The method of claim 19, wherein mounting the at least one rail mounting bracket to the at least one cart rail includes providing an interference-fit connection between the at least one rail mounting bracket and the at least one cart rail.

21. The method of claim 19, wherein mounting the at least one cart rail to the at least one rail mounting bracket includes inserting first and second free edges of the at least one cart rail into first and second recesses formed in the at least one rail mounting bracket.

22. The method of claim 21, wherein the first and second recesses are arranged perpendicular to each other.
